(19) United States
(12) Patent Application Publication
(10) Pub. No.: US 2022/0129745 A1
(43) Pub. Date: Apr. 28, 2022

(54) Prediction and Management of System Loading

(71) Applicant: SAP SE, Walldorf (DE)

(72) Inventors: Deng Feng Wan, Shanghai (CN); Hui Zhang, Shanghai (CN); Zuxing Wang, Shanghai (CN); Yangchun Deng, Shanghai (CN)

(21) Appl. No.: 17/081,579

(22) Filed: Oct. 27, 2020

(51) Int. Cl. G06N 3/08; G06F 16/25

(52) U.S. Cl. CPC G06N 3/08; G06F 16/258

(57) ABSTRACT

Supervised learning creates and trains a model to predict resource consumption by a remote system. Historical time-series data (e.g., monitor logs of CPU consumption, memory consumption) are collected from systems called upon to perform a task. This raw data is transformed into a labeled data set ready for supervised learning. Using the labeled data set, a model is constructed to correlate the input data with a resulting load. The constructed model may be a Sequence to Sequence (Seq2Seq) model based upon Gated Recurrent Units of a Recurrent Neural Network. After training, the model is saved for re-use to predict future load based upon an existing input. For example, the existing input may be data from a most recent 24 hour period (hour0-hour23), and the output of the model may be the load predicted for the next 24 hour period (hour24-hour47). This prediction promotes efficient reservation remote server resources.

### BACKGROUND

Unless otherwise indicated herein, the approaches described in this section are not prior art to the claims in this application and are not admitted to be prior art by inclusion in this section.

The advent of high communications bandwidth and rapid data handling, allows software services to increasingly be deployed on cloud systems that are located on remote servers. Having access to such server infrastructure is a precious and expensive commodity.

However, such remote server environments can be subject to significant variations in load demand Nevertheless, in order to assure user access, the available capacities for such remote server resources must be reserved for and paid in advance of actual needs. This can possibly result in excess payment for unused server capacity.

### SUMMARY

Embodiments implement the prediction and management of system loading, in order to increase the efficiency of resource utilization and reduce cost. Specifically, a supervised learning procedure is used to create and train a model that is capable of accurately predicting the future consumption of available resources. Historical time-series data in the form of monitor logs containing relevant resource information (e.g., CPU consumption, memory consumption, network bandwidth usage, others) are collected from systems being called upon to perform a task. This raw data set is transformed into a labeled data set ready for supervised learning. The labeled data set has input data and target data.

Using the labeled data set, a model is constructed to correlate the input data with a resulting load. According to particular embodiments, the model constructed is a Seq2Seq (sequence to sequence) model based upon Gated Recurrent Units (GRUs) of a Recurrent Neural Network (RNN).

After training with the labeled dataset, the model is saved for re-use to predict future load based upon a new input. For example, the new input (not part of the training corpus) may be data from a most recent 24 hour period (hour0-hour23), and the corresponding output of the model may be the load predicted for the next 24 hour period (hour24-hour47). Having this predictive load data in advance, allows more accurate adjustment of the reserved infrastructure capacity, and hence reduction in cost attributable to unused resources.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 1A shows a simplified flow diagram of a method according to an embodiment.

FIGS. 2A-B show simplified views of Gated Recurrent Units (GRUs).

FIG. 2C shows a simplified view of a seq2seq model.

FIG. 2D shows a more detailed view of a seq2seq model.

FIG. 3 illustrates a block diagram of an architecture for load prediction

FIG. 4 illustrates the data handling to create a vector.

FIG. 5 shows exemplary calculation code logic.

FIG. 6 shows a simplified view of constructing the training data set.

FIGS. 7A-B show code logic for constructing the training data set.

FIG. 8 shows a simplified high-level structure of an exemplary model.

FIG. 9 shows a simplified view of the encoder according to this example.

FIG. 10 shows an exemplary code piece for encoding.

FIG. 11 shows an exemplary code piece for attention.

FIG. 12 shows a simplified view of an exemplary decoder.

FIG. 13 shows an exemplary code piece for the decoder.

FIG. 14 shows an exemplary code piece for combining the encoder, attention, and decoder elements.

FIG. 15 shows an exemplary training code piece.

FIG. 16 is a simplified flow diagram showing sequence of events for model training.

FIG. 17 illustrates hardware of a special purpose computing machine according to an embodiment that is configured to implement prediction of system loading.

FIG. 18 illustrates an example computer system.

### DETAILED DESCRIPTION

Described herein are methods and apparatuses that implement prediction of system loading. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

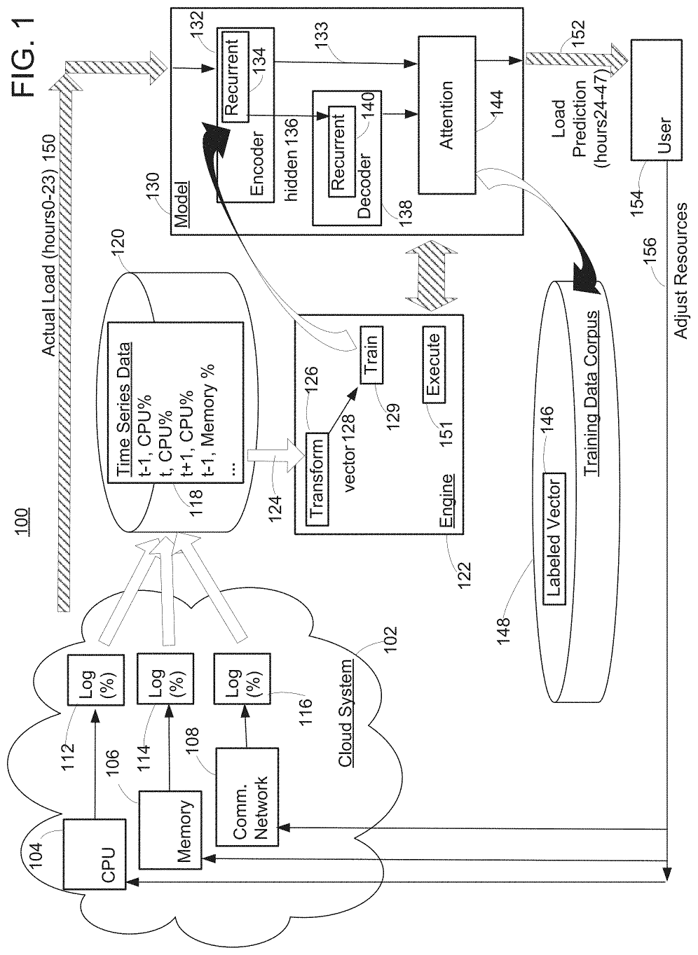

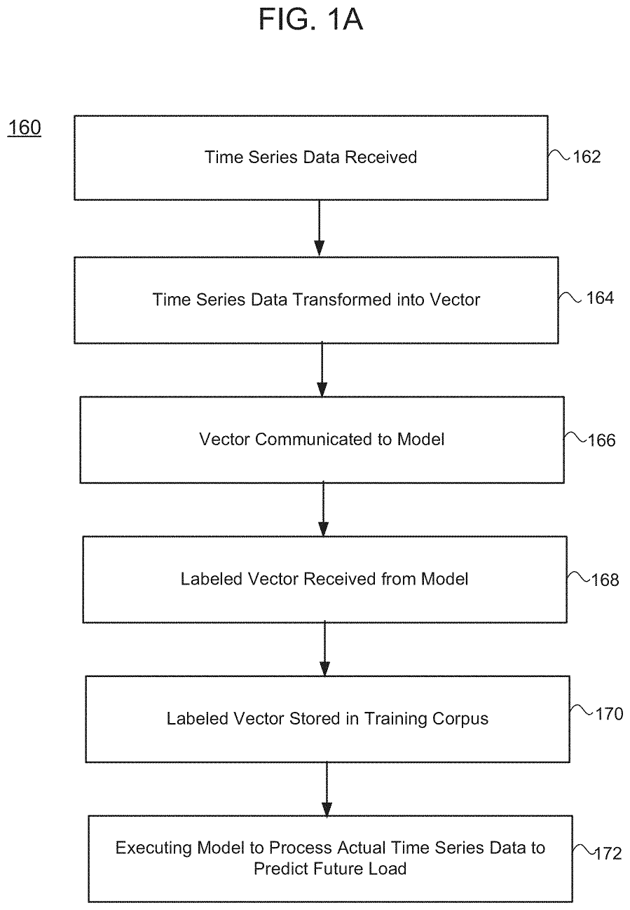

FIG. 1 shows a simplified view of an example system that is configured to implement load prediction according to an embodiment. Specifically, system 100 comprises a cloud system 102 that consumes various resources in the course of performing a task. Examples include processing resources 104, memory resources 106, network communications resources 108, and others.

The cloud system further includes monitor logs 110 that are equipped to collect time series information regarding the consumption of the various resources. Thus, a first monitor log 112 collects time series data regarding CPU consumption, a second monitor log 114 collects time series data regarding memory consumption, and a third monitor log 116 collects time series data regarding available transmission bandwidth usage. This time series data of resource consumption, may be expressed in terms of percentages.

This time series data 118 relating to cloud system resource utilization, is collected over a long time period. This (voluminous) time series data is stored in a non-transitory computer readable storage medium 120.

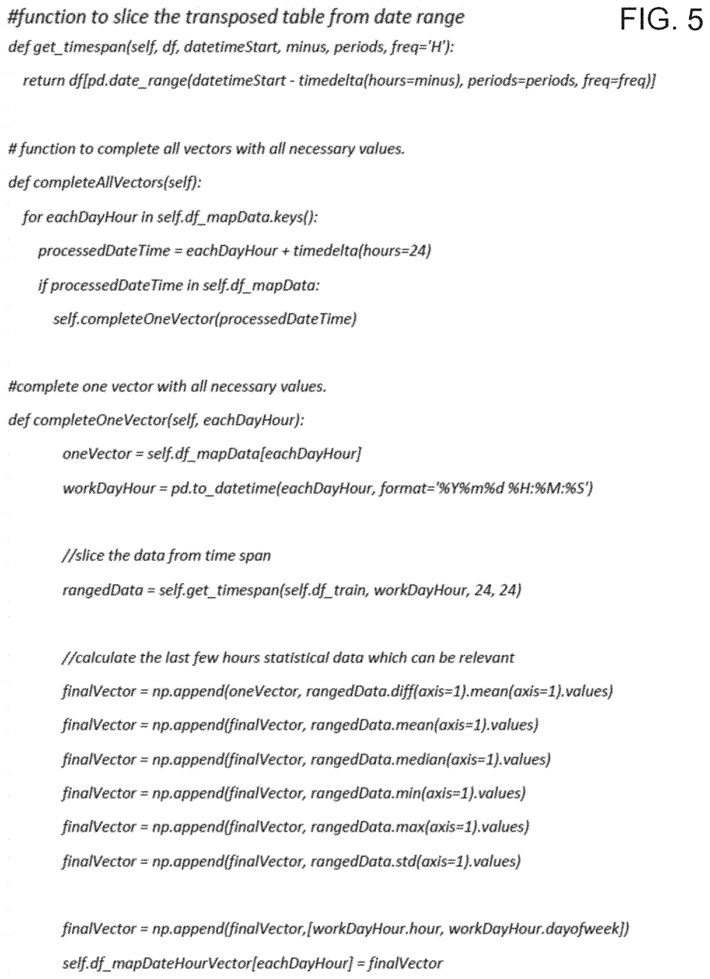

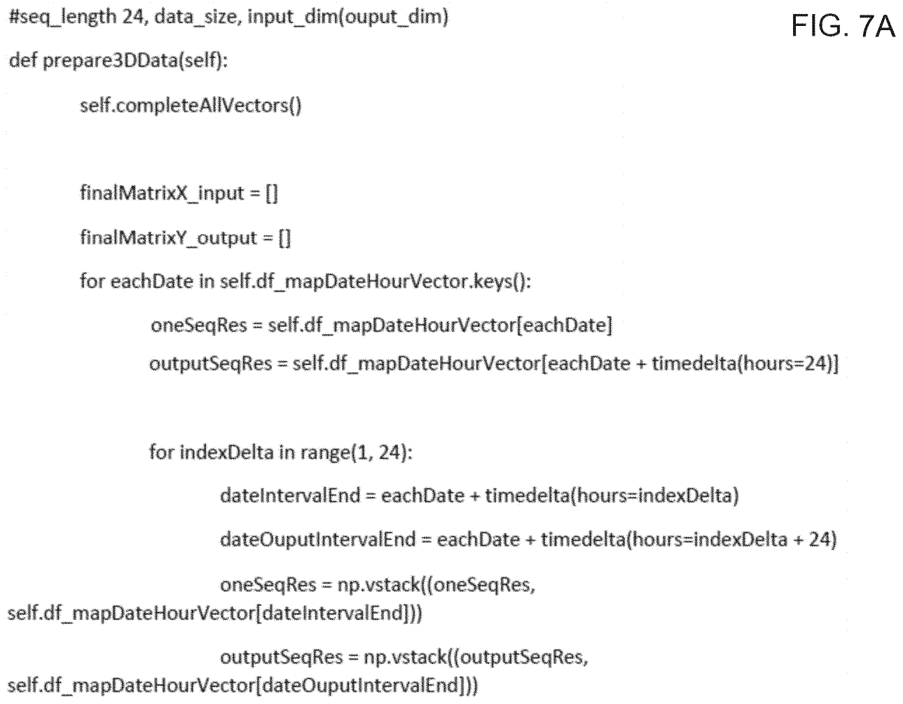

Next, an engine 122 is configured to intake 124 the time series data, and to perform processing of that data. In particular, the engine first transforms 126 the time series data into a vector 128 format. This transformation can be performed in conjunction with a map, and details are provided in connection with the example below in at least FIGS. 4 and 6.

Next, as part of a training process 129, the engine communicates the vector to a model 130 that is constructed to predict future load based upon an existing load. In particular embodiments, the model is a sequence to sequence (Seq2Seq) model comprising an encoder 132 that receives the input vector, and provides corresponding encoded output 133.

In certain embodiments, the encoder comprises a recurrent unit 134—e.g., a Gated Recurrent Unit (GRU). That recurrent unit is also configured to output a hidden state 136.

The hidden state information is received by a decoder 138, which may also comprise a recurrent unit 140. The decoder produces a corresponding output 142.

The attention component 144 of the model receives the encoded output and the decoder output. The attention component produces a labeled output vector 146 that is stored in a training data corpus 148.

This transformation of time series data, followed by training of the model utilizing the resulting vector, continues for most if not all of the large volume of stored time series data. In this manner, the model is trained to accurately reflect the past resource consumption of the system based upon the historical time series inputs.

Then, as shown in FIG. 1, the trained model can receive as input from the cloud system, actual time series (e.g., hour0-hour23) load data 150. Then, the engine executes 151 the model upon this input to provide as an output, a prediction 152 of future load (e.g., hour24-hour47) of the cloud system.

This prediction may be received by a user 154. The user may then reference this prediction to provide an instruction 156 to adjust resources within the cloud system. For example, if the prediction forecasts reduced demand, the user can instruct dropping resources in order to lower cost.

FIG. 1A is a flow diagram of a method 160 according to an embodiment. At 162, time series data reflection consumption of a resource is received.

At 164, the time series data is transformed into a vector. At 166, the vector is communicated to an encoder of a model to cause a recurrent unit to generate a hidden state.

At 168, a labeled vector is received reflecting processing of the hidden state by the model. At 170 the labeled vector is stored in a training data corpus.

At this point, the model is trained. At 172, the trained model executes upon actual time series load data received, in order to produce an accurate output prediction of future load. In particular, this accurate output prediction reflects the prior training of the model based upon historical load behavior.

Further details regarding the implementation of system loading according to various embodiments, are now provided in connection with the following example.

### Example

In this example, monitor logs of CPU, and Memory were collected from a system of a SUCCESFACTORS data center. Together with the time series loading data, the monitor log information was transformed by labeling into machine learning ready data set for supervised learning. In particular, the machine learning data corpus has input data and target data.

With this labeled data set, a seq2seq (sequence to sequence) model was constructed based upon a Recurrent Neural Network (RNN). Specifically, a RNN is a class of artificial neural networks where connections between nodes form a directed graph along a temporal sequence.

This structure allows a RNN to exhibit temporal dynamic behavior. RNNs can use their internal memory state to process input sequences having variable length. This property renders RNN suited to performing certain tasks such as speech recognition.

After training the seq2seq model with the labeled dataset, that model is saved for re-use in predicting future system loading with new inputs. That is, the trained seq2seq model can be loaded, and recent 24 hours data (hour0-hour23) from the SUCCESSFACTORS data center input thereto. In response, the trained model will predict the load for the next 24 hours (hour24-hour47).

Having this predictive load data from the trained model in hand, allows accurate adjustment of the infrastructure capacity of the SUCCESSFACTORS data center system as necessary. As one possible example, where the trained model predicts an increased peak load, the data center system can be horizontally scaled out for more machines. Conversely, for the low load prediction some virtual machines (VMs) can be shut down—saving cost.

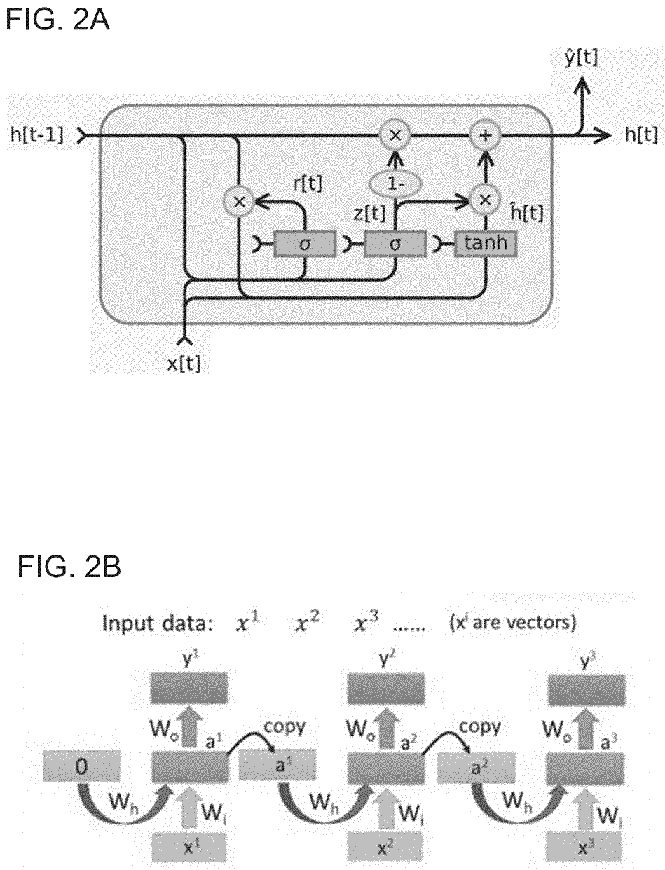

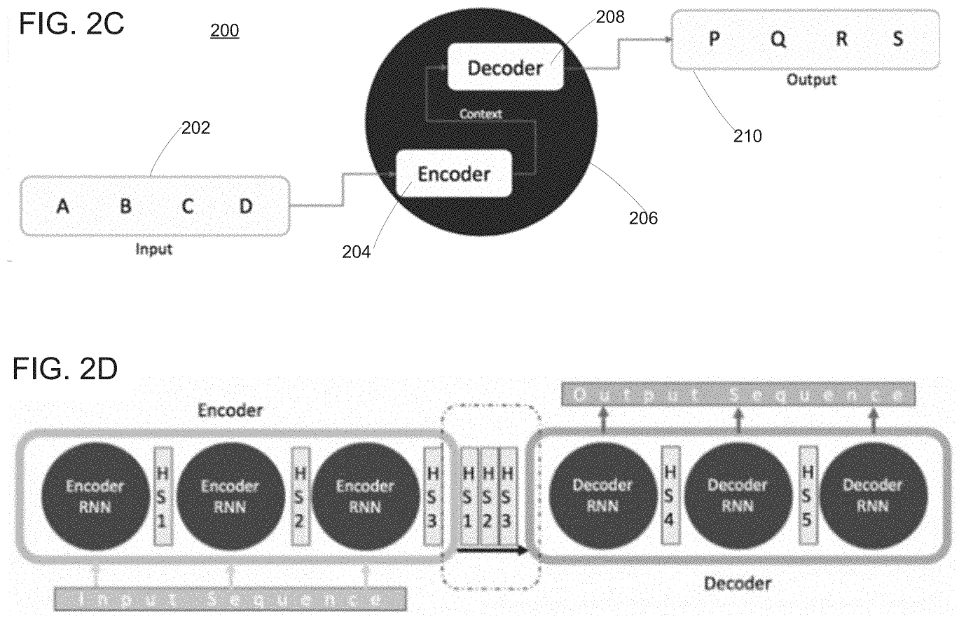

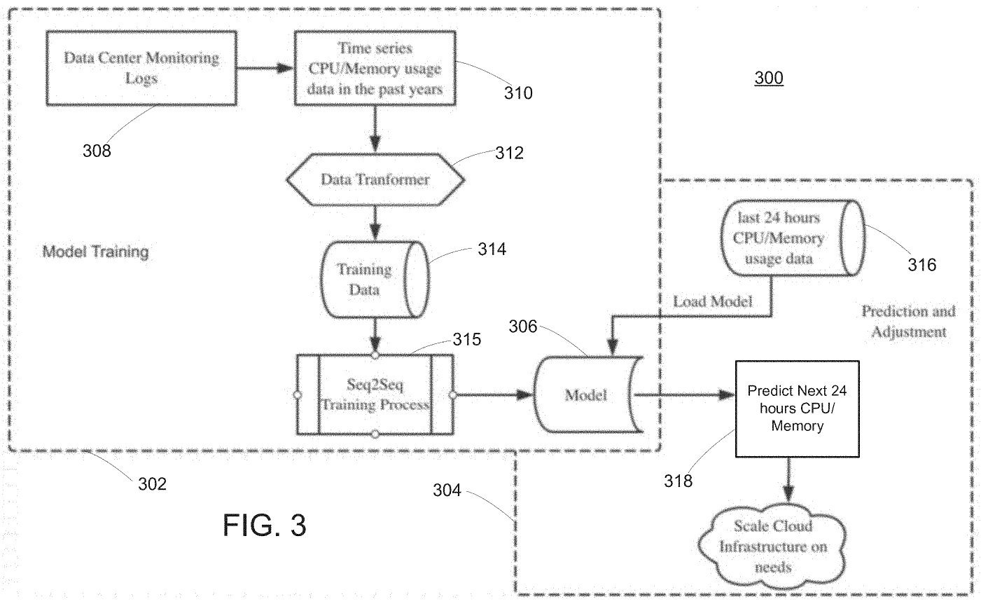

For the instant specific example, the RNN utilizes Gated Recurrent Units (GRUs) as a gating mechanism. As shown in FIG. 2A, the GRU is like a long short-term memory (LSTM) with a forget gate, but has fewer parameters than a LSTM. In processing certain smaller and less frequent datasets, a GRU may exhibit performance that is improved as compared with a LSTM.

The GRU receives an input vector x, and a hidden state h(t−1), where t is time. The GRU produces a corresponding output vector y, and a hidden state h(t).

FIG. 2B shows a view of three GRUs. Each GRU sequentially receives the hidden state (Wₕ) from the upstream GRU. For the initial GRU in the sequence, the hidden state may be zero.

Details regarding the particular supervised learning model used in this example—the Sequence to Sequence (Seq2Seq) model—are now discussed. FIG. 2C shows a simplified view of a Seq2Seq model.

In particular, a Seq2Seq model 200 takes a sequence 202 of items (e.g., words, letters, time series, etc) as input to an encoder 204 within a context 206. A decoder 208 then outputs another sequence 210 of items.

FIG. 2D shows a more detailed example of a Seq2Seq model utilizing multiple RNNs. Here, the Hidden State (HS) outputs of an encoder RNN feed as inputs to corresponding decoder RNNs.

It is noted that where the input sequence is time-series data (e.g., as for the system monitor log data of this example), the volume of inputs can be increased by incrementally shifting (e.g., by one hour) the time-series forward and/or backward. This serves to quickly increase the volume of data available for training the model, and hence the ultimate expected accuracy of the model once it is trained.

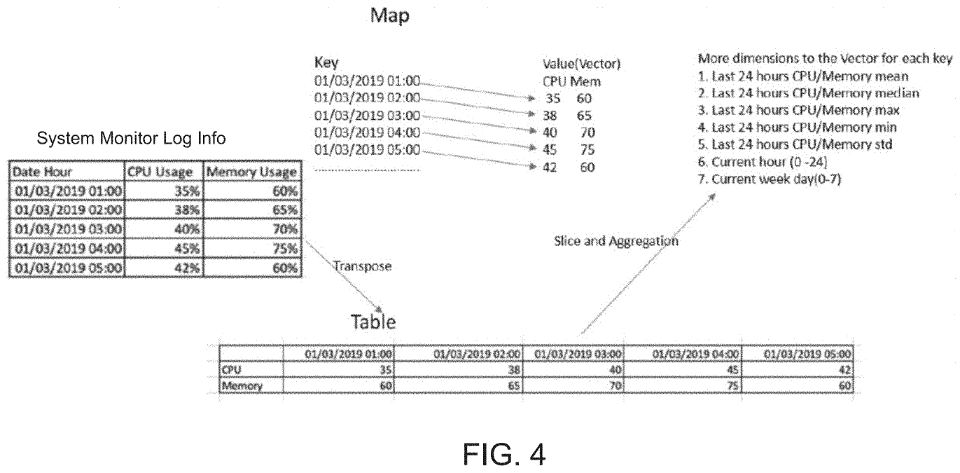

FIG. 3 illustrates a high-level block diagram of an architecture 300 for performing load prediction according to this example. There are two major components.

The left side of FIG. 3 shows the model training part 302. The right side of FIG. 3 shows the model prediction and adjustment part 304.

For purposes of training the Seq2Seq model 306, actual data center monitoring logs 308 (e.g., CPU, Memory) were collected. Together with the time series CPU/Memory load data in the past few years 310, we can run the data transformer 312 to transform the data to be training data corpus 314.

Then, inputting the training data corpus to seq2seq model, we can train 315 the model which can fit DC status.

After the trained model is saved, it can be loaded for use. With actual recent 24 hours CPU/Memory usage data 316 as input, the trained model can output a predicted load 318 for the next 24 hours. Given this prediction, the cloud infrastructure can be scaled as needed, with attendant cost savings.

Details regarding the data transformer element of this example, are now provided. As shown in FIG. 4, a map with temporal (date, time) information (e.g., Jan. 3, 2019 01:00) is used as a key to create a value in the form of a vector.

With hourly monitor information available in the form of CPU usage and memory usage, a HashMap can be prepared. The key is the hourly date time. The value is numeric value of CPU/Memory percent.

Now, we have only two numbers for each vector. Accordingly, we will construct even more numeric values for the vector.

We transpose the original data hour/CPU/Memory data set, so that its columns will be date hour and two rows would be CPU and Memory load. This will be used for the next calculation in the following step.

For each vector from a specific date/time hour, it may be desired to inject more information for that time hour. For example, we want to calculate last 24 hours CPU/Memory mean/max/min/std values.

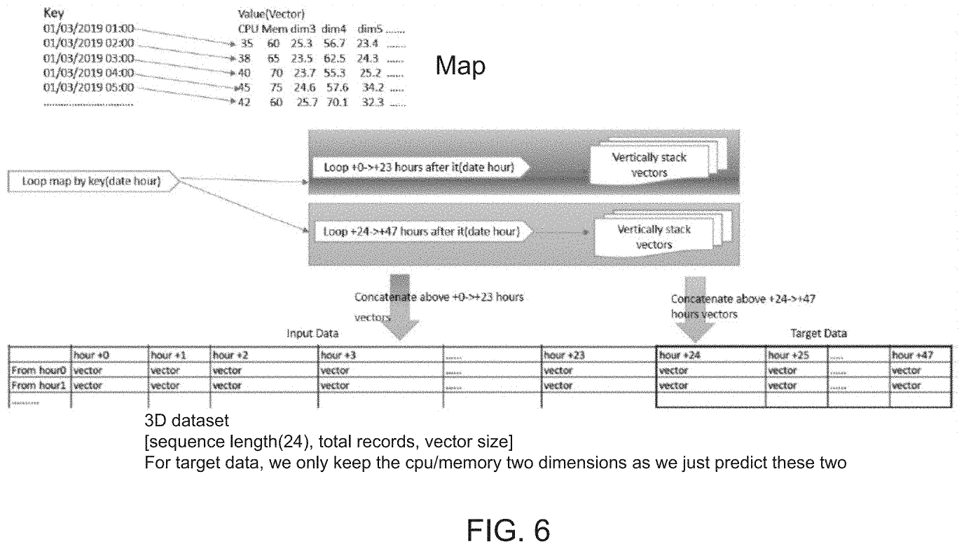

We also want to inject the weekday and current hour information to the vector, because we know these will be related to the load. This can be done utilizing the exemplary calculation code logic shown in FIG. 5.

The next activity is to construct the training data set from the HashMap of the preceding step. This training data set includes an input data set and a corresponding target data set.

FIG. 6 shows a simplified view of constructing the training data set. Here, we are going to construct a 3-Dimensional (3-D) data set. Each dimension represents respectively:

an hour index(0-23);

records number;

a vector size.

We loop the HashMap by key(date time hour) for each one. We retrieve 23 hours data(vector) after it. Thus, there will be 24 hours data as input data, and we can vertically stack all vectors.

We then retrieve hour 24 to 47 (inclusive) hours data(vector). Together, there will be a full 24 hours data as target data. We also vertically stack these vectors.

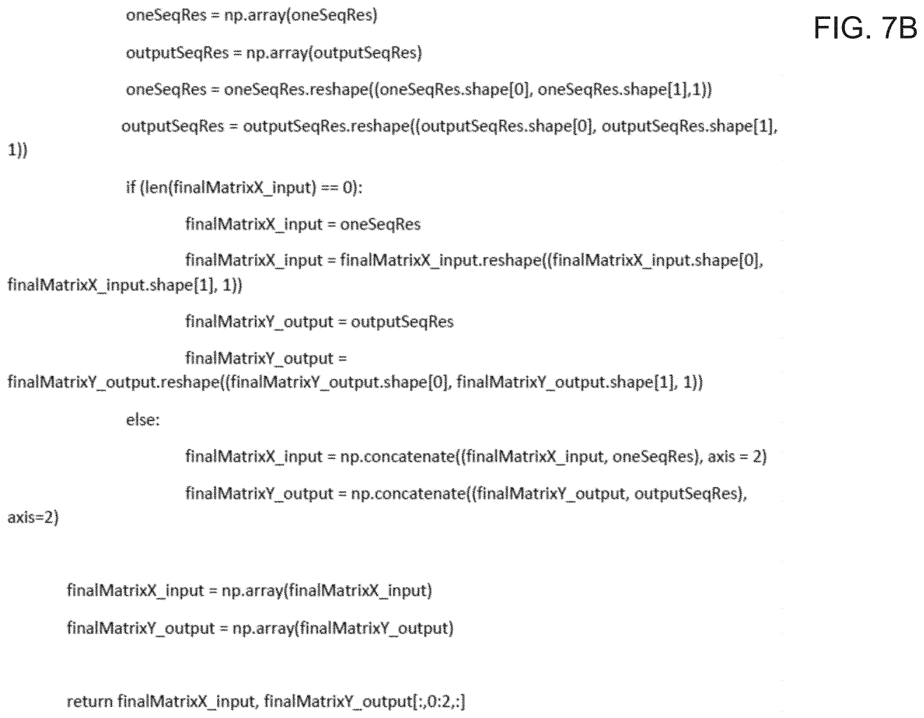

While looping the map keys, we then concatenate the input data as the input data set. We also concatenate the target data as the target data set. This can form the 3-D data set as described above. FIGS. 7A-B show the corresponding code logic with python.

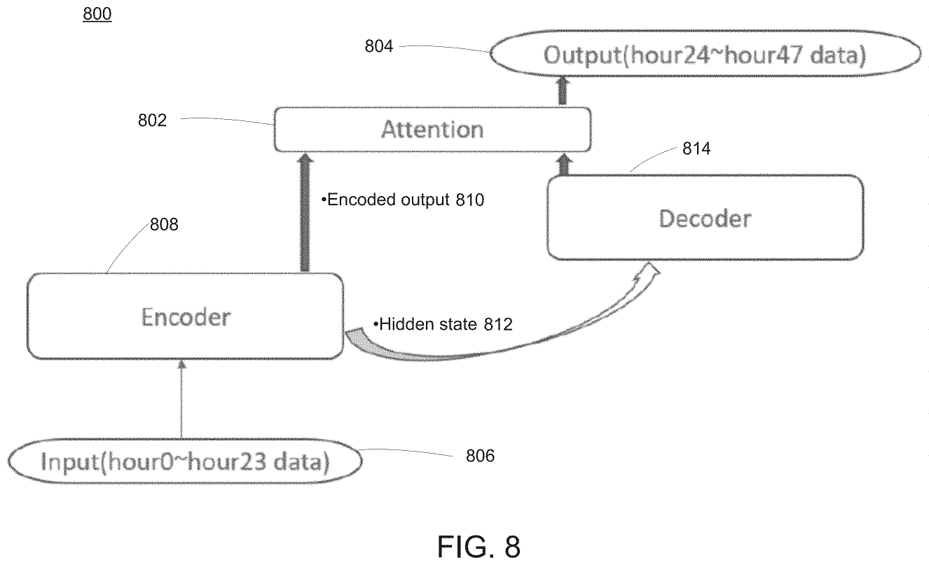

Details regarding the Seq2seq model used in this example, are now described. In particular, we can build a seq2seq model to train the data set. The high-level structure of the model is as shown in the simplified view of FIG. 8.

Specifically, the seq2seq model 800 with attention 802 is used to predict sequential data set 804 with the input 806 also being a sequence. The model will also take the output of the encoder 808 as attention.

This exemplary model will take the input data from hour 0 to hour 23. After going through the encoder, it will produce encoded output 810 and hidden state 812. The encoded output will be used as attention.

Also the hidden state can be used as input of the decoder 814. The decoder will also consume the attention data. Eventually, the decoder generate a series of vectors of next 24 hours data. For the sake of simplicity, this example only considers CPU usage and Memory usage, so only a few 2-feature vectors are output.

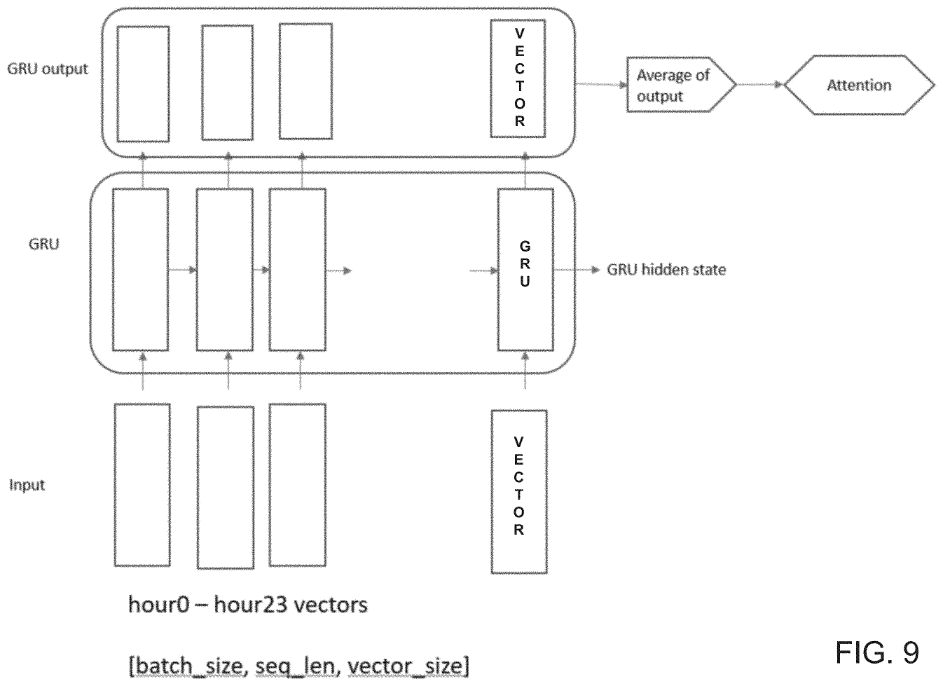

FIG. 9 shows a simplified view of the encoder according to this example. Here, the encoder uses a GRU structure. With the input as a data set comprising:

[batch_size, seq_len(24), vector_size],

the encoder output has the size of:

[seq_len, batch_size, enc_hidden_size].

The hidden state has a size of:

[1, batch_size, enc_hidden_size].

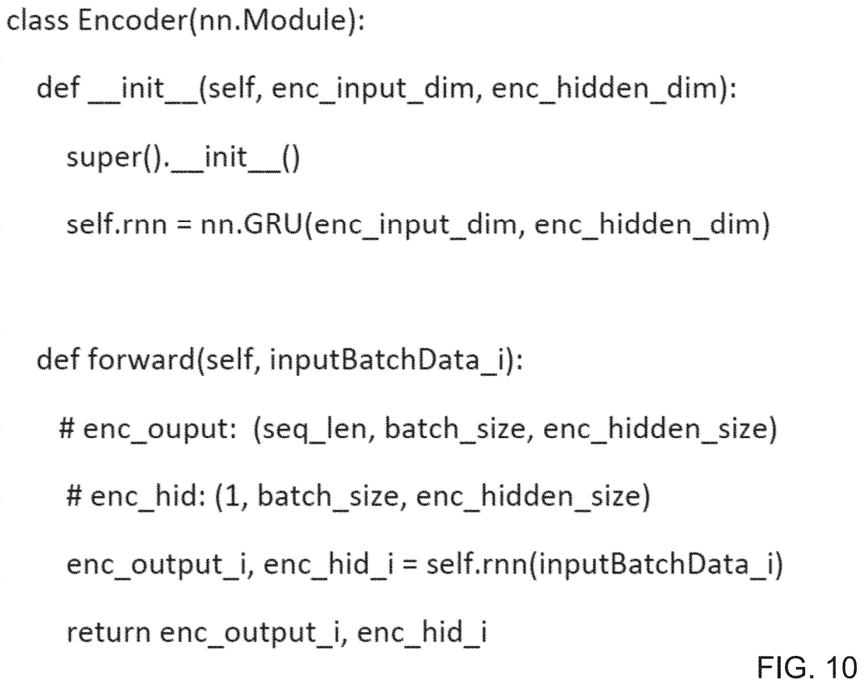

An exemplary code piece for this encoding is shown in FIG. 10:

This particular example uses a simple attention. The encoder output is averaged, and eventually the size is:

[batch_size, hidden_size].

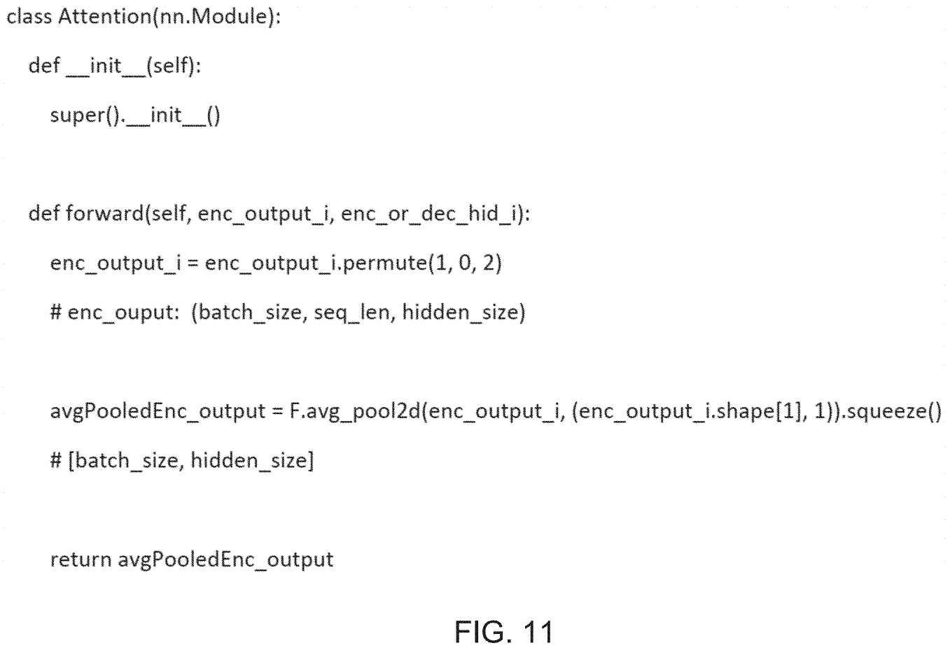

An exemplary code piece for this attention is shown in FIG. 11.

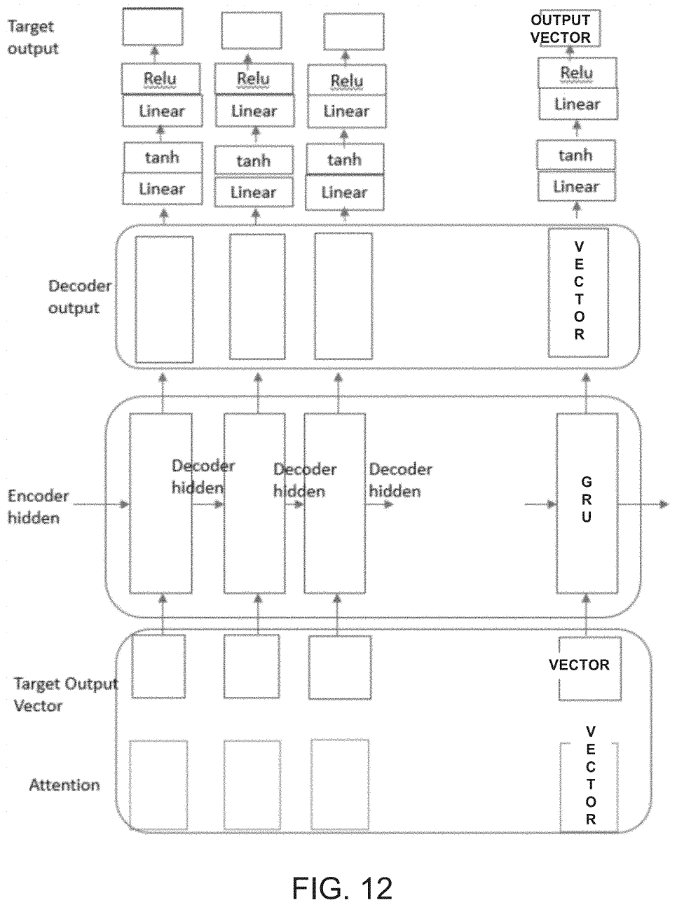

FIG. 12 shows a simplified view of the Decoder according to this example. A GRU is also used as a decoder component.

Specifically, for each input we combine the target output vector with the attention from the encoder. The first hidden state input is from the encoder.

As shown in FIG. 12, the decoder output would firstly be linearly transformed, then go through a tanh function. After that, the output would go through another linear function and Relu activation function.

Eventually, for each GRU its output size is:

[batch, 2].

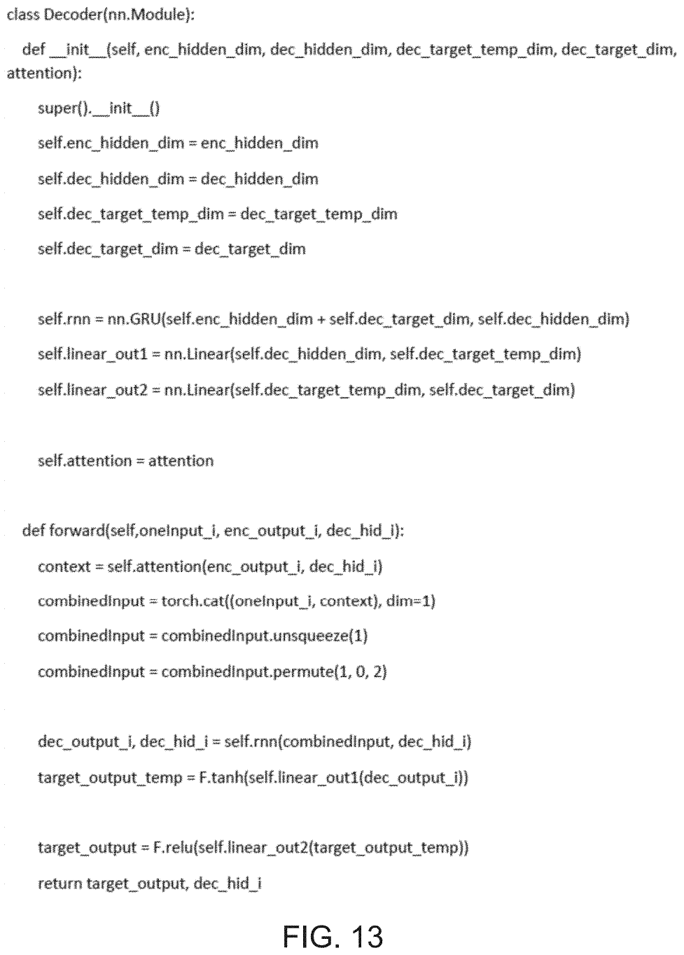

An exemplary code piece for the decoder is shown in FIG. 13.

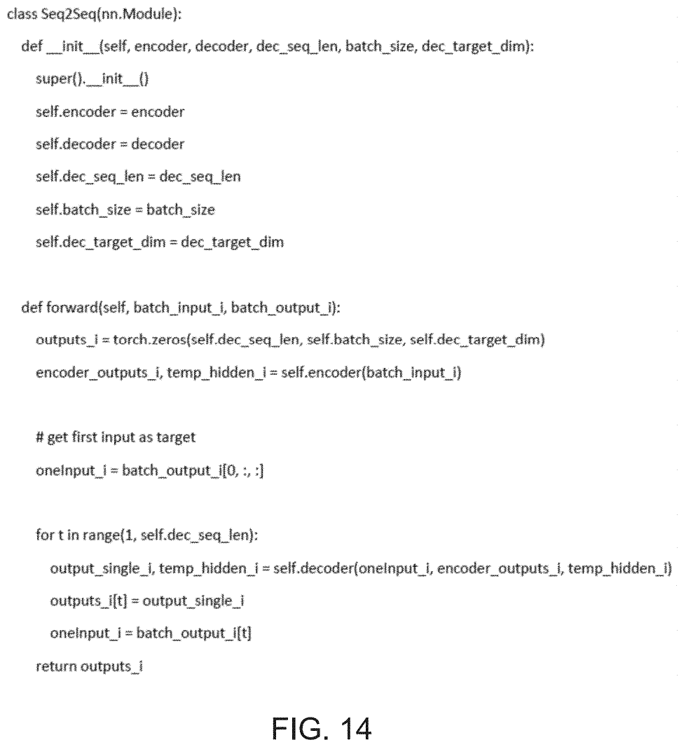

Combining the Encoder, Attention, and Decoder elements yields a complete Seq2Seq model. The code piece for this combining is as shown in FIG. 14.

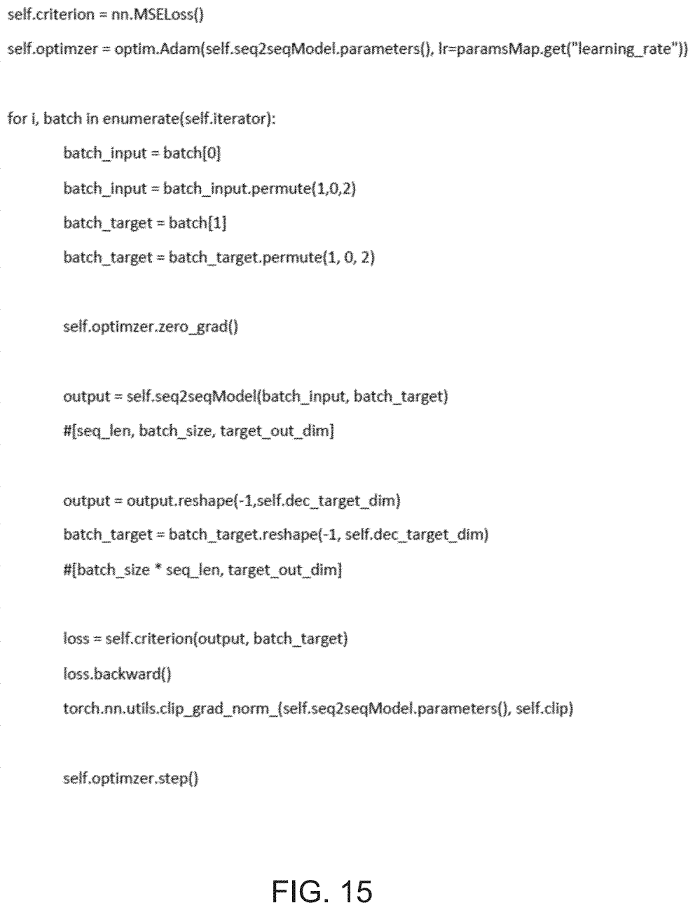

Training of the Seq2Seq model of this example is now discussed. Here, the loss function of Mean Squared Error (MSE) is used. However, this is no required and loss could be calculated in other ways. The corresponding training code piece is as shown in FIG. 15.

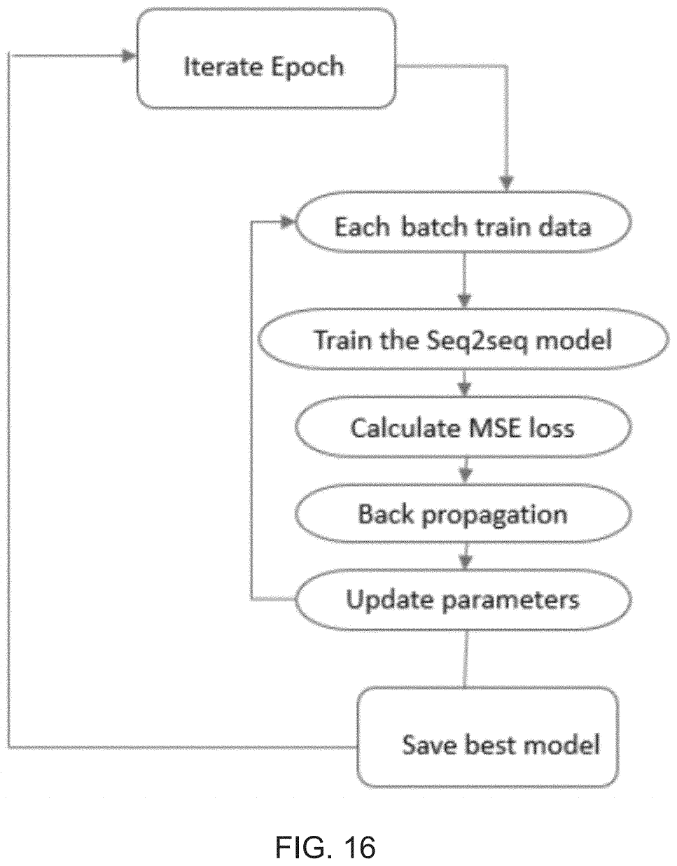

For each batch training data, we train the seq2seq model, then calculate the MSE loss, with back propagation, then update parameters. During epoch iteration, we can save the best model with least loss. This sequence of events is shown in the simplified flow diagram of FIG. 16.

Prediction of future load based upon actual input (e.g., hour0-hour23) of time-series monitor log data to the trained model, is now discussed. Specifically, after loading the model saved from above step, we can input recent 24 hours data as input data, and the trained model would output the predicted data. This can be used for infrastructure capacity adjustments.

Returning now to FIG. 1, there the particular embodiment is depicted with the engine responsible for load prediction being located outside of the computer readable storage media storing the historical time series data, and the training data corpus. However, this is not required.

Rather, alternative embodiments could leverage the processing power of an in-memory database engine (e.g., the in-memory database engine of the HANA in-memory database available from SAP SE), in order to perform various functions.

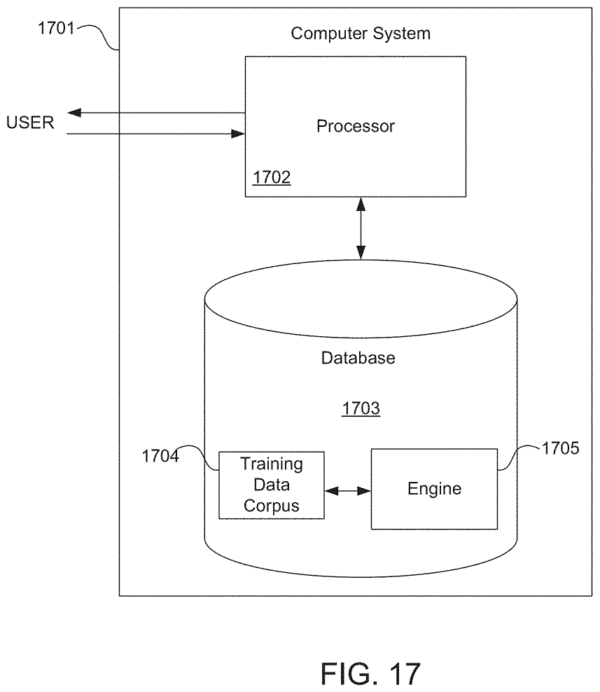

Thus FIG. 17 illustrates hardware of a special purpose computing machine configured to implement load prediction according to an embodiment. In particular, computer system 1701 comprises a processor 1702 that is in electronic communication with a non-transitory computer-readable storage medium comprising a database 1703. This computer-readable storage medium has stored thereon code 1705 corresponding to an engine. Code 1704 corresponds to a training data corpus. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

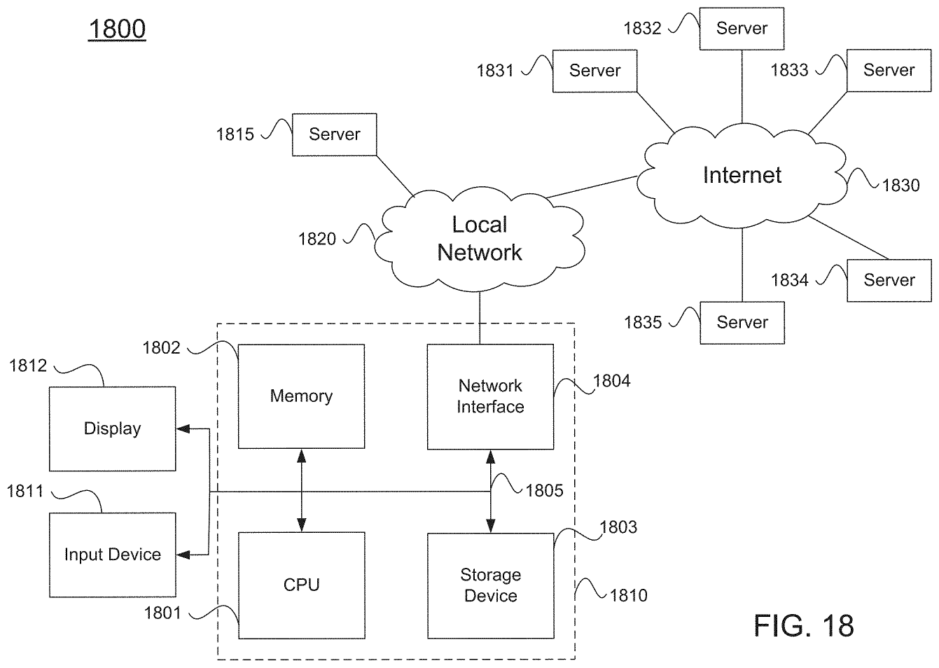

An example computer system 1800 is illustrated in FIG. 18. Computer system 1810 includes a bus 1805 or other communication mechanism for communicating information, and a processor 1801 coupled with bus 1805 for processing information. Computer system 1810 also includes a memory 1802 coupled to bus 1805 for storing information and instructions to be executed by processor 1801, including information and instructions for performing the techniques described above, for example. This memory may also be used for storing variables or other intermediate information during execution of instructions to be executed by processor 1801. Possible implementations of this memory may be, but are not limited to, random access memory (RAM), read only memory (ROM), or both. A storage device 1803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1803 may include source code, binary code, or software files for performing the techniques above, for example. Storage device and memory are both examples of computer readable mediums.

Computer system 1810 may be coupled via bus 1805 to a display 1812, such as a cathode ray tube (CRT) or liquid crystal display (LCD), for displaying information to a computer user. An input device 1811 such as a keyboard and/or mouse is coupled to bus 1805 for communicating information and command selections from the user to processor 1801. The combination of these components allows the user to communicate with the system. In some systems, bus 1805 may be divided into multiple specialized buses.

Computer system 1810 also includes a network interface 1804 coupled with bus 1805. Network interface 1804 may provide two-way data communication between computer system 1810 and the local network 1820. The network interface 1804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 1810 can send and receive information, including messages or other interface actions, through the network interface 1804 across a local network 1820, an Intranet, or the Internet 1830. For a local network, computer system 1810 may communicate with a plurality of other computer machines, such as server 1815. Accordingly, computer system 1810 and server computer systems represented by server 1815 may form a cloud computing network, which may be programmed with processes described herein. In the Internet example, software components or services may reside on multiple different computer systems 1810 or servers 1831-1835 across the network. The processes described above may be implemented on one or more servers, for example. A server 1831 may transmit actions or messages from one component, through Internet 1830, local network 1820, and network interface 1804 to a component on computer system 1810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving first historical time series data reflecting consumption of a resource by a system over a time interval having a first start time and a first end time;
transforming the first historical time series data into a first vector;
communicating the first vector to an encoder component of a model to cause a first recurrent unit to generate a first hidden state;
receiving from an attention component of the model, a first labeled vector reflecting processing of the first hidden state by a second recurrent unit of a decoder component of the model; and
storing first the labeled vector as a training data corpus in a non-transitory computer readable storage medium.

2. A method as in claim 1 wherein the first recurrent unit comprises a first Gated Recurrent Unit (GRU), and the second recurrent unit comprises a second GRU.

3. A method as in claim 1 further comprising:
incrementally changing the first start time and the first end time to create second historical time series data;
transforming the second historical time series data into a second vector;
communicating the second vector to the encoder component of the model to cause the first recurrent unit to generate second hidden state;
receiving from the attention component of the model, second first labeled vector reflecting processing of the second hidden state by the second recurrent unit of the decoder component of the model; and
storing the second labeled vector in the training data corpus in the non-transitory computer readable storage medium.

4. A method as in claim 1 wherein the transforming comprises preparing a hashmap with a unique key-value pair comprising:
a key with a time; and
a value of consumption of the resource at the time, expressed as a percentage.

5. A method as in claim 1 wherein:
the system comprises a Central Processing Unit (CPU); and
the time-series data reflects CPU consumption.

6. A method as in claim 1 wherein:
the system comprises memory; and
the time-series data reflects memory consumption.

7. A method as in claim 1 wherein:
the system comprises a communications network; and
the time-series data reflects communications network bandwidth usage.

8. A method as in claim 1 further comprising:
executing the model upon actual time series data received from the system to produce a prediction of future consumption of resources; and
communicating the prediction to a user.

9. A method as in claim 1 wherein:
the non-transitory computer readable storage medium comprises an in-memory database; and
the transforming is performed by an in-memory database engine of the in-memory database.

10. A non-transitory computer readable storage medium embodying a computer program for performing a method, said method comprising:
receiving first historical time series data reflecting consumption of a resource by a system over a time interval having a first start time and a first end time;
transforming the first historical time series data into a first vector by preparing a hashmap with a unique key-value pair comprising,
a key with a time, and
a value of consumption of the resource at the time, expressed as a percentage;
communicating the first vector to an encoder component of a model to cause a first recurrent unit to generate a first hidden state;
receiving from an attention component of the model, a first labeled vector reflecting processing of the first hidden state by a second recurrent unit of a decoder component of the model; and
storing first the labeled vector as a training data corpus in a non-transitory computer readable storage medium.

11. A non-transitory computer readable storage medium as in claim 10 wherein the first recurrent unit comprises a first Gated Recurrent Unit (GRU), and the second recurrent unit comprises a second GRU.

12. A non-transitory computer readable storage medium as in claim 10 wherein the method further comprises:
incrementally changing the first start time and the first end time to create second historical time series data;
transforming the second historical time series data into a second vector;
communicating the second vector to the encoder component of the model to cause the first recurrent unit to generate second hidden state;
receiving from the attention component of the model, second first labeled vector reflecting processing of the second hidden state by the second recurrent unit of the decoder component of the model; and
storing the second labeled vector in the training data corpus in the non-transitory computer readable storage medium.

13. A non-transitory computer readable storage medium as in claim 10 wherein the system comprises at least one of:
a Central Processing Unit (CPU), and the time-series data reflects CPU consumption;
a memory, and the time-series data reflects memory consumption; or
a communications network, and the time-series data reflects communications network bandwidth usage.

14. A non-transitory computer readable storage medium as in claim 10 wherein the method further comprises:
executing the model upon actual time series data received from the system to produce a prediction of future consumption of resources; and
communicating the prediction to a user.

15. A computer system comprising:
one or more processors;
a software program, executable on said computer system, the software program configured to cause an in-memory database engine of an in-memory database to:
receive first historical time series data reflecting consumption of a resource by a system over a time interval having a first start time and a first end time;
transform the first historical time series data into a first vector;
communicate the first vector to an encoder component of a model to cause a first recurrent unit to generate a first hidden state;
receive from an attention component of the model, a first labeled vector reflecting processing of the first hidden state by a second recurrent unit of a decoder component of the model; and
store first the labeled vector as a training data corpus in the in-memory database.

16. A computer system as in claim 15 wherein the first recurrent unit comprises a first Gated Recurrent Unit (GRU), and the second recurrent unit comprises a second GRU.

17. A computer system as in claim 15 wherein the in-memory database engine is further configured to:
incrementally change the first start time and the first end time to create second historical time series data;
transform the second historical time series data into a second vector;
communicate the second vector to the encoder component of the model to cause the first recurrent unit to generate second hidden state;
receive from the attention component of the model, second first labeled vector reflecting processing of the second hidden state by the second recurrent unit of the decoder component of the model; and
store the second labeled vector in the training data corpus in the in-memory database.

18. A computer system as in claim 15 wherein the system comprises at least one of:
a Central Processing Unit (CPU), and the time-series data reflects CPU consumption;
a memory, and the time-series data reflects memory consumption; or
a communications network, and the time-series data reflects communications network bandwidth usage.

19. A computer system as in claim 15 wherein the transform comprises preparing a hashmap with a unique key-value pair comprising:
a key with a time; and
a value of consumption of the resource at the time, expressed as a percentage.

20. A computer system as in claim 15 wherein the in-memory database engine is further configured to:
execute the model upon actual time series data received from the system to produce a prediction of future consumption of resources; and
communicate the prediction to a user.
